(19) United States
(12) Patent Application Publication
(10) Pub. No.: US 2009/0071618 A1
(43) Pub. Date: Mar. 19, 2009

(54) HIGH-PERFORMANCE STRENGTH RESINS IN PAPERMAKING INDUSTRIES

(75) Inventors: Naijie Zhang, Ridgefield, CT (US); Michael S. Ryan, Newtown, CT (US)

Correspondence Address: CANTOR COLBURN, LLP, 20 Church Street, 22nd Floor, Hartford, CT, 06103, US

(73) Assignee: KEMIRA OYJ, Helsinki (FI)

(21) Appl. No.: 11/571,768

(22) PCT Filed: Apr. 19, 2005
(86) PCT No.: PCT/US2005/013333

§ 371 Date: Nov. 11, 2008

Related U.S. Application Data
(60) Provisional application No. 60/586,394, filed on Jul. 8, 2004.

(51) Int. Cl. D21H 17/38; C08G 69/48; C08G 73/06

(52) U.S. Cl. 162/164.6; 525/421; 525/417

(57) ABSTRACT

A composition comprising a functionalized water-soluble, cationic, thermosetting, cellulose reactive polymer with a doubly structured backbone that is the reaction product of: (a) a copolymerized (i) acrylamide component, (ii) cationic co-monomer component and (iii) at least one multifunctional crosslinking monomer component; and (b) a cellulose reactive agent component; such that the acrylamide component, the cationic co-monomer component, the multifunctional crosslinking monomer component, and the cellulose reactive agent component are in an amount sufficient amount to produce a polymer that imparts strength to a fibrous substrate when the polymer is added to paper stock during a papermaking process. The invention also relates to methods for making and using such a composition.

### BACKGROUND

Chemical additives are typically used during papermaking processes to improve the strength properties of paper and paperboard. The primary purpose of such chemical additives is to enhance interfiber bonding in the paper sheet.

There are many benefits to be gained from the use of strength additives. Strength additives enable the papermaker to use less pulp, less expensive pulp and/or more filler while making a sufficiently strong, stiff and opaque paper product. In addition, refining can be reduced while maintaining paper strength, resulting in energy savings and increased production. Certain agents provide additional strength to paper when wet. These agents are particularly important to paper grades such as tissue, towel, board, currency, and many others.

There are many different chemical additives that have been utilized as strength additives. Conventional strength additives include starch, vegetable gums, carboxymethyl cellulose, urea-formaldehyde resins, melamine-formaldehyde resins, acrylamide copolymers and polyamidoamine-epichlorohydrin resins.

U.S. Pat. No. 3,556,932 to Coscia discloses water-soluble glyoxalated acrylamide copolymers as strength additives. The acrylamide copolymers are prepared by the solution copolymerization of acrylamide with a cationic monomer such as diallyldimethylammonium chloride. The polymers are subsequently reacted with glyoxal in a dilute, aqueous solution to impart —CONHCHOHCHO functionalities onto the polymer and to increase the molecular weight of the polymer through glyoxal cross-links. The resulting resins are used extensively as dry strength and wet strength additives in papermaking industries.

U.S. Pat. No. 3,311,594 discloses the manufacture and use of polyamidoamine/epichlorohydrin (PAE) resins as wet strength additives for paper. The resins are prepared by reacting epichlorohydrin with polyamidoamines. The PAE resins also impart limited dry strength to paper. However, since the PAE resins impart vast wet strength to paper, which results in papers containing these resins difficult to repulp, PAE resins are unsuitable for use as dry strength resins in the production of recyclable paper.

It would be beneficial to develop improved compositions and methods for imparting dry strength to paper products.

### SUMMARY

The invention relates to a composition comprising a functionalized water-soluble, cationic, thermosetting, cellulose reactive polymer with a doubly structured backbone that is the reaction product of: (a) a copolymerized (i) acrylamide component, (ii) cationic co-monomer component and (iii) at least one multifunctional crosslinking monomer component; and (b) a cellulose reactive agent component; such that the acrylamide component, the cationic co-monomer component, the multifunctional crosslinking monomer component, and the cellulose reactive agent component are in an amount sufficient amount to produce a polymer that imparts strength to a fibrous substrate when the polymer is added to paper stock during a papermaking process. These and other features, aspects, and advantages of the present invention will become better understood with reference to the following description and appended claims.

### DESCRIPTION

The invention is based on the discovery that by adding a multifunctional crosslinking monomer component during copolymerization of (i) an acrylamide component, and (ii) a cationic co-monomer component, forming a structured backbone and then subjecting the resulting polymer to reaction with a cellulose reactive agent component and forming a polymer with a doubly structured backbone, it is now possible to form a polymer that has improved performance, as compared to a polymer that does not have doubly structured backbone. This is a remarkable discovery, because it would be unexpected that subjecting the backbone to further structuring would affect the polymer's performance.

As used herein, the term “multifunctional crosslinking monomer component” includes bifunctional monomers as well as multifunctional monomers.

Other than in the operating examples or where otherwise indicated, all numbers or expressions referring to quantities of ingredients, reaction conditions, etc., used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

The acrylamide component includes those polymers formed from acrylamide and/or methacrylamide or an acrylamide copolymer containing acrylamide and/or methacrylamide as a predominant component among all monomers making up the copolymer. When employed as a paper strength agent, however, the acrylamide polymer preferably contains acrylamide and/or methacrylamide in a proportion of 50 mole % or more, or more particularly from 74 to 99.97 mole %, or from 94 to 99.98 mole %.

The amount of the acrylamide component generally ranges from 70 to 99%, based on the total weight of the copolymer. In one embodiment, the acrylamide component ranges from 75 to 95%.

Up to about 10% by weight, of the acrylamide comonomer of the structured polymers may be replaced by other comonomers copolymerizable with the acrylamide. Such comonomers include acrylic acid, acrylic ester such as ethyl acrylate, butyl acrylate, methylmeth-acrylate, 2-ethylhexyl acrylate etc., acrylonitrile, N,N′-dimethyl acrylamide, N-tert-butyl acrylamide, 2-hydroxylethyl acrylate, styrene, vinylbenzene sulfonic, vinyl pyrrolidon.

The cationic comonomer is generally any cationic comonomer, which when used in accordance to the invention, produces a polymer in accordance to the invention. Examples of suitable cationic co-monomers include but are not limited to diallyl dimethylammonium chloride, acryloyloxytrimethylammonium chloride, methacryloyloxytrimethylammonium chloride, methacrylamidopropyl trimethylammonium chloride, 1-methacryloyl-4-methyl piperazine, and combinations thereof. The amount of the cationic monomer generally ranges from 1 to 30%, or from 5 to 25% based on the total weight of the copolymer. The polymer may also be rendered cationic through reaction of the acrylamide polymer such as the Hofmann degradation.

The multifunctional crosslinking monomer component can vary. Examples of suitable monomers include but are not limited to methylenebisacrylamide; methylenebismethacrylamide; triallylammonium chloride; tetraallylammonium chloride; polyethyleneglycol diacrylate; polyethyleneglycol dimethacrylate; N-vinyl acrylamide; divinylbenzene; tetra (ethylene glycol) diacrylate; dimethylallylaminoethylacrylate ammonium chloride; diallyloxyacetic acid, Na salt; diallyloctylamide; trimethylolpropane ethoxylate triacrylate; N-allylacrylamide N-methylal-lylacrylamide, and combinations thereof. The amount of the multifunctional crosslinking component varies. Examples of suitable monomers can be found in WO 97/18167 and U.S. Pat. No. 4,950,725, incorporated herein by reference in its entirety.

In one embodiment, the amount is at least 20 ppm, e.g., from 20 to 20,000 ppm, or from 100 to 1,000 ppm based on the total weight of the polymer.

The cellulose reactive agent component can be any agent, which when used in accordance to the invention, produces a polymer with a doubly structured backbone, such that the polymer imparts strength to a fibrous substrate when the polymer is added to paper stock during a papermaking process. Examples of suitable cellulose reactive agents include and are not limited to the group consisting of glyoxal, glutaraldehyde, furan dialdehyde, 2-hydroxyadipaldehyde, succinaldehyde, dialdehyde starch, diepoxy compounds, and combinations thereof.

The use of the cellulose reactive agents imparts useful functionalization to the polymers. Glyoxalation, for instance, of the structured-branched polyacrylamide introduces CHO functionalities into the polymer and also increases the molecular weight by introducing cross-linking into the polymer structure. The structuring and branching of the polymer may additionally effect the degree of glyoxalation and thereby, the polymer performance. The glyoxalated structured-branched polyacrylamides exhibit improvement of the properties of strength for paper over the conventional glyoxalated polyacrylamides.

The amount of cellulose reactive agent can vary with application and can range from 10 to 100%, or from 40 to 50% based on the total weight of the backbone copolymer.

The molecular weight of the backbone can vary. In one embodiment, the backbone has a molecular weight, prior to reaction with the cellulose reactive agent component, ranging from 1,000 to 100,000 daltons, preferably 1,500 to 30,000 daltons. All molecular weights herein are weight average.

The bulk viscosity of the copolymer can vary, depending on application. Generally, the viscosity of the copolymer is in the range of 10-5,000 cps, or more particularly from 150-500 cps at 40% total solids. The chain transfer agent is used in the range of 0 to 15%, preferred range from 0-10.0%, by weight, based on the total weight of the copolymer. The ratio of cellulose reactive units to acrylamide units can range from 0.1-0.5:1.0, respectively.

The chain transfer agent is an optional component and can include any chain transfer agent, which when used in conjunction with the invention, produces a doubly structured backbone, such that the polymer imparts strength to a fibrous substrate when the polymer is added to paper stock during a papermaking process. Examples of suitable transfer agents are selected from the group consisting of 2-mercaptoethanol; lactic acid; isopropyl alcohol; thioacids; and sodium hypophosphite. Preferred chain transfer agents are 2-mercaptoethanol, lactic acid, and isopropyl alcohol. The amounts of transfer agent can vary. Generally, such a transfer agent is present in an amount ranging from 0 to 15%, or more particularly from 0 to 10%.

The polymers of the invention are cationic and made typically by free radical polymerization. The cationicity of the polymer can vary. In one embodiment, the polymer is cationic due to a polymer reaction such as the Hofmann degradation. The polymers can include anionic and non-ionic functionalities and, as such, the polymers can include amphoteric polymers.

The invention provides a process for making a polymer that involves the steps of (a) copolymerizing an acrylamide component and a cationic monomer component with at least one multifunctional crosslinking monomer component, and thereby forming a structured cationic branched polyacrylamide with a structured backbone; (b) reacting the structured-branched polyacrylamide with a cellulose reactive agent component, and thereby forming a functionalized water-soluble, cationic, thermosetting, and cellulose reactive polymer with a doubly structured backbone; such that the acrylamide component, the cationic co-monomer component, the multifunctional crosslinking monomer component, and the cellulose reactive agent component are in an amount sufficient to produce a polymer that imparts strength to a fibrous substrate when the polymer is added to paper stock during a papermaking process. The artisan will appreciate that the polymers of the invention can also contain anionic, and nonionic groups. Controlling the level of crosslinker and, optionally, a chain transfer agent, can control the degree of structuring, branching, and molecular weight.

The process is carried out in the presence of an initiator component and a suitable solvent component under conditions that produce the water-soluble, cationic, thermosetting, and cellulose reactive polymer. Any conventional initiator may be employed to initiate polymerization, including thermal, redox and ultraviolet radiation. Examples of suitable initiators include and are not limited to azobisisobutyronitrile; sodium sulfite; sodium metabisulfite; 2,2′-azobis(2-methyl-2-amidinopropane) dihydrochloride; ammonium persulfate and ferrous ammonium sulfate hexahydrate. In one advantageous embodiment, ammonium persulfate/sodium metabisulfite, and combinations thereof can be used. Organic peroxides may also be employed for polymerizing ethylenically unsaturated monomers. A particularly preferred initiator for the purpose of this invention is ammonium persulfate/sodium metabisulfite. See Modern Plastics Encyclopedia/88, McGraw Hill, October 1987, pp. 165-168.

During functionalization, the solids of the backbone polymer can differ. In one embodiment, the backbone polymer solids during functionalization is from 4 to 15%, or more particularly from 5 to 10%.

The fibrous substrate is generally a paper sheet made from a suitable paper slurry (furnish). The furnish from which the fibrous substrate is made can include any furnish that produces a fibrous substrate suitable for this invention. Furnishes, for instance, can include tissue furnishes, towel furnishes, wet laid furnishes, virgin or recycle furnishes or treated cellulosic furnishes. Depending on the application, the number of fibrous substrates in a paper product can vary. The paper product can have more than one fibrous substrate. In one embodiment, the paper product has two fibrous substrates, e.g., a two-ply paper product. In another embodiment, the paper product can have more than two fibrous substrates.

In use, the invention provides a method that involves the steps of (a) providing paper stock; (b) adding to the paper stock a functionalized water-soluble, cationic, thermosetting, and cellulose reactive polymer that is the reaction product of: (1) a copolymerized (i) acrylamide component, (ii) cationic co-monomer component and (iii) at least one multifunctional crosslinking monomer component; and (2) a cellulose reactive agent component; and (3) forming a web from the paper stock; such that the acrylamide component, the cationic co-monomer component, the multifunctional crosslinking monomer component, and the cellulose reactive agent component are in an amount sufficient amount to produce a polymer that imparts strength to a fibrous substrate when the polymer is added to paper stock during a papermaking process.

The polymer can be added to a furnish at various papermaking pHs, depending on the application. In one embodiment, the polymer is added to the fiber furnish with papermaking pH ranging from 3 to 10. In one embodiment, the pH ranges from 5 to 7.

The benefits of cellulose reactive functionalized glyoxalated structured polyacrylamides tend to be more visible in the strength of the paper, particularly recycled paper. The glyoxalated structured polyacrylamides are readily adsorbed to cellulose fiber at pH values within the range of 3.0-8.0. The resins provide strength to paper by forming hydrogen bonds and covalent bonds as well as ionic bonds with cellulose fiber.

The amounts at which the composition of the invention is used can also vary, depending on the application. In one embodiment, the polymer is added to the fiber furnish at a dose of from 0.5 to 20 lb/ton (0.25-10 kg/metric ton), or more particularly from 2 to 13 lb/ton (1-6.5 kg/metric ton) dry polymer solids based on dry fiber. The artisan will appreciate that these are guidelines and that the actually effective dosage of the resin depends on the nature of the furnish and the conditions of the white water.

The invention provides previously unavailable advantages. The improved dry strength additives of the invention, for instance, better enable papermakers to use less pulp, less expensive pulp and/or more filler while making sufficiently strong, stiff and opaque paper product, as compared to ordinary compositions and methods. In addition, refining can be reduced while maintaining paper strength, resulting in energy savings and increased production. The improved wet strength allows papermakers to make higher wet strength paper or use lower chemical dosages incurring cost efficiencies and improved machine runnability.

Although the present invention has been described in detail with reference to certain preferred versions thereof, other variations are possible. Therefore, the spirit and scope of the appended claims should not be limited to the description of the versions contained therein.

What is claimed is:

1. A composition comprising a functionalized water-soluble, cationic, thermosetting, cellulose reactive polymer with a doubly structured backbone that is the reaction product of:
(a) a copolymerized (i) acrylamide component, (ii) cationic co-monomer component and (iii) at least one multifunctional crosslinking monomer component; and
(b) a cellulose reactive agent component;
wherein the acrylamide component, the cationic co-monomer component, the multifunctional crosslinking monomer component, and the cellulose reactive agent component are in an amount sufficient amount to produce a polymer that imparts strength to a fibrous substrate when the polymer is added to paper stock during a papermaking process.

2. The polymer of claim 1, wherein the acrylamide component ranges from 70 to 99%.

3. The polymer of claim 1, where the cationic comonomer ranges from 1 to 30%, based on the total weight of the copolymer.

4. The polymer of claim 1, wherein the multifunctional crosslinking monomer component ranges from 20 to 20,000 ppm, based on the total weight of the polymer.

5. The polymer of claim 1 wherein the cellulose reactive agent component ranges from 10 to 100%, based on the total weight of the backbone.

6. The polymer of claim 1, wherein the acrylamide component is selected from the group consisting of acrylamide, methacrylamide, and combinations thereof.

7. The polymer of claim 1, wherein the cationic co-monomer is selected from the group consisting of diallyl dimethylammonium chloride, acryloyloxytrimethylammonium chloride, methacryloyioxytrimethylam monium chloride, methacrylamidopropyn trimethylammonium chloride, 1-methacryloyl-4-methyl piperazine, and combinations thereof.

8. The polymer of claim 1, wherein the multifunctional crosslinking monomer component is selected from the group consisting of methylenebisacrylamide; methylenebismethacrylamide; triallylammonium chloride; tetraallylammonium chloride; polyethyleneglycol diacrylate; polyethyleneglycol dimethacrylate; N-vinyl acrylamide; divinylbenzene; tetra (ethylene glycol) diacrylate; dimethylallylaminoethylacrylate ammonium chloride; diallyloxyacetic acid, Na salt; diallyloctylamide; trimethylolpropane ethoxylate triacrylate; N-allylacrylamide N-methylal-lylacrylamide, and combinations thereof.

9. The polymer of claim 1, wherein the cellulose reactive component is selected from the group consisting of glyoxal, glutaraldehyde, furan dialdehyde, 2-hydroxyadipaldehyde, succinaldehyde, dialdehyde starch, diepoxy compounds, and combinations thereof.

10. The polymer of claim 1, wherein the backbone has a molecular weight, prior to reaction with the cellulose reactive agent component, ranging from 1,000 to 100,000 daltons.

11. The polymer of claim 1, wherein the backbone further comprises a chain transfer agent in the amount ranging from 0 to 15%.

12. The polymer of claim 11, wherein the chain transfer agent is selected from the group consisting of 2-mercaptoethanol; lactic acid; isopropyl alcohol; thioacids; sodium hypophosphite, and combinations thereof.

13. A process for making a polymer comprising:
(a) copolymerizing an acrylamide component and a cationic monomer component with at least one multifunctional crosslinking monomer component, and thereby forming a structured cationic branched polyacrylamide with a structured backbone;
(b) reacting the structured-branched polyacrylamide with a cellulose reactive agent component, and thereby forming a functionalized water-soluble, cationic, thermosetting, and cellulose reactive polymer with a doubly structured backbone;
wherein the acrylamide component, the cationic co-monomer component, the multifunctional crosslinking monomer component, and the cellulose reactive agent component are in an amount sufficient amount to produce a polymer that imparts strength to a fibrous substrate when the polymer is added to paper stock during a papermaking process.

14. The process of claim 13, wherein the solution polymerization is carried out in the presence of a chain transfer agent.

15. The process of claim 13, wherein the backbone polymer solids during functionalization is from 4 to 15%.

16. The process of claim 13, wherein the initiator is selected from the group consisting of azobisisobutyronitrile; sodium sulfite; sodium metabisulfite; 2,2′-azobis(2-methyl-2-amidinopropane) dihydrochloride; ammonium persulfate, ferrous ammonium sulfatehexahydrate, sodium metabisulfite, and combinations thereof.

17. The process of claim 13, wherein the polymer is cationic due to polymer reaction such as the Hofmann degradation rather than through use of a cationic comonomer.

18. A method comprising:
(a) providing paper stock;
(b) adding to the paper stock a functionalized water-soluble, cationic, thermosetting, and cellulose reactive polymer that is the reaction product of:
(1) a copolymerized (i) acrylamide component, (ii) cationic co-monomer component and (iii) at least one multifunctional crosslinking monomer component; and
(2) a cellulose reactive agent component; and
(c) forming a web from the paper stock;
wherein the acrylamide component, the cationic co-monomer component, the multifunctional crosslinking monomer component, and the cellulose reactive agent component are in an amount sufficient to produce a polymer that imparts strength to a fibrous substrate when the polymer is added to paper stock during a papermaking process.

19. The method of claim 17, wherein the polymer is added to the fiber furnish with papermaking pH ranging from 4 to 10.

20. The method of claim 17, wherein the polymer is added to the fiber furnish with papermaking pH ranging from 4 to 8.

21. The method of claim 17, wherein the polymer is added to the fiber furnish at a dose ranging from (0.25 to 10 kg/metric ton) dry polymer solids based on dry fiber.

22. The paper resultant from process of claim 17.

23. The process of claim 17, wherein the web formed from the paper stock exhibits a dry strength that is at least 15% more, as compared to a web made during a process that does not use a polymer with a doubly structured backbone.

24. The process of claim 23, wherein the dry strength is from 15 to 30% more, as compared to a web made during a process that does not use a polymer with a doubly structured backbone.

25. The process of claim 17, wherein the web formed from the paper stock exhibits a wet strength that is at least 15% more, as compared to a web made during a process that does not use a polymer with a doubly structured backbone.

26. The process of claim 17, wherein the web formed from the paper stock exhibits a wet strength that is at least 15 to 30% more, as compared to a web made during a process that does not use a polymer with a doubly structured backbone.
